(19) United States
(12) Patent Application Publication
(10) Pub. No.: US 2025/0211948 A1
(43) Pub. Date: Jun. 26, 2025

(54) COMMUNICATION TERMINAL AND CONTROL METHOD

(71) Applicant: ICOM INCORPORATED, Osaka (JP)

(72) Inventor: Keishiro UWAMORI, Osaka (JP)

(21) Appl. No.: 18/999,198

(22) Filed: Dec. 23, 2024

(30) Foreign Application Priority Data
Dec. 26, 2023 (JP) 2023-220055

(51) Int. Cl. H04W 4/10; H04M 7/00

(52) U.S. Cl. CPC H04W 4/10; H04M 7/006

(57) ABSTRACT

To provide a communication terminal capable of carrying out appropriate switching between a plurality of communication methods. A communication terminal includes: a call control section which controls calling carried out by an IP wireless processing section for IP wireless communication and an IP telephone processing section for IP telephone calling. The call control section carries out control so that (a) in a case where IP wireless communication calling is carried out by a main body-side speaker and a main body-side microphone at the time when a handset is brought into an off-hook state, IP wireless communication calling is carried out by the handset and (b) in a case where IP wireless communication is not carried out at the time when the handset is brought into an off-hook state, IP telephone calling is carried out by the handset.

### CROSS-REFERENCE TO RELATED APPLICATIONS

This Nonprovisional application claims priority under 35 U.S.C. §119 on Patent Application No. 2023-220055 filed in Japan on Dec. 26, 2023, the entire contents of which are hereby incorporated by reference.

### DESCRIPTION

### Technical Field

The present invention relates to a communication terminal and a method for controlling the communication terminal.

### Background Art

Heretofore, there has been proposed a relay device which relays, over a network, voice communication of transceivers or telephones. By connecting a plurality of relay devices via a network, it is also possible to enable voice communication between different types of communication devices such as between an IP telephone and a wireless device.

Patent Literature 1 discloses a relay device which enables switching a transmission control system for a voice signal from one to another in accordance with a function of a destination of communication. In a case where an SIP telephone makes a call to an analog transceiver, the relay device determines an address and a device type of the analog transceiver on the basis of calling information, and transmits, to the analog transceiver, a voice signal according to a transmission control system suitable for the analog transceiver.

There is also a practically-used communication terminal having both (a) an IP telephone call function which operates according to SIP and (b) a PTT call function which operates according to the PTT method by using an IP network. In the descriptions below, for convenience, communication according to the PTT method will be referred to as “IP wireless communication” and calling via the IP wireless communication will be referred to as “IP wireless calling”, even in a case where the communication terminal is in connected in a wired manner.

### CITATION LIST

### Patent Literature

### [Patent Literature 1]

Japanese Patent Application Publication, Tokukai, No. 2020-53837

### SUMMARY OF INVENTION

### Technical Problem

With the communication terminal having both the IP telephone call function and the IP wireless call function, calling is carried out via a single microphone and a single speaker. In this case, switching between the IP telephone call function and the IP wireless call function is carried out in response to an instruction input from a user. Meanwhile, for example, a stationary communication terminal including a main body-side speaker, a main body-side microphone, a handset-side speaker, and a handset-side microphone has room for improvement in the way of switching between the IP telephone call function and the IP wireless call function.

An aspect of the present invention has an object to provide a communication terminal and the like each of which has both an IP telephone call function and an IP wireless call function, the communication terminal and the like enabling easy switching between the IP telephone call function and the IP wireless call function.

### Solution to Problem

In order to attain the object, a communication terminal in accordance with an aspect of the present invention includes: a Push to Talk call processing section which carries out Push to Talk calling according to a Push to Talk method; an Internet Protocol telephone processing section which carries out Internet Protocol telephone calling according to Session Initiation Protocol via an Internet Protocol network; a call control section which controls (a) Push to Talk calling via the Push to Talk call processing section and (b) Internet Protocol telephone calling via the Internet Protocol telephone processing section; a main body including a main body-side speaker and a main body-side microphone; and a handset t including a handset-side speaker and a handset-side microphone, the call control section carrying out control so that (a) in a case where the Push to Talk calling is carried out by the main body-side speaker and the main body-side microphone at a time when the handset is brought into an off-hook state, the Push to Talk calling is carried out by the handset and (b) in a case where the Push to Talk calling is not carried out at a time when the handset is brought into an off-hook state, the Internet Protocol telephone calling is carried out by the handset.

Further, a method for controlling a communication terminal in accordance with an aspect of the present invention is a method for controlling a communication terminal that includes: a Push to Talk call processing section which carries out Push to Talk calling according to a Push to Talk method; an Internet Protocol telephone processing section which carries out Internet Protocol telephone calling according to Session Initiation Protocol via an Internet Protocol network; a main body which includes a main body-side speaker and a main body-side speaker; and a handset which includes a handset-side speaker and handset-side microphone, the method including the steps of: controlling the Push to Talk call processing section so that, in a case where the Push to Talk calling is carried out by the main body-side speaker and the main body-side microphone at a time when the handset is brought into an off-hook state, the Push to Talk calling is carried out by the handset; and controlling the Internet Protocol telephone processing section so that, in a case where the Push to Talk calling is not carried out at a time when the handset is brought into an off-hook state, the Internet Protocol telephone calling is carried out by the handset.

Each of the communication terminals in accordance with the foregoing aspects of the present invention may be realized by a computer. In such a case, the present invention encompasses: a control program for the communication terminal which program causes computer to operate as the foregoing sections (software elements) of the communication terminal so that the communication terminal can be realized by the computer; and a computer-readable storage medium storing the control program therein.

### Advantageous Effects of Invention

In accordance with an aspect of the present invention, it is possible to provide a communication terminal and the like each of which is capable of easily carrying out switching between an IP telephone call function and an IP wireless call function.

### BRIEF DESCRIPTION OF DRAWINGS

FIG. 1 is a view illustrating an example of a configuration of a communication system including a communication terminal in accordance with a first embodiment.

FIG. 2 is a plan view illustrating an example of an appearance of the communication terminal in accordance with the first embodiment.

FIG. 3 is a block diagram illustrating an example of a configuration of a main part of the communication terminal in accordance with the first embodiment.

FIG. 4 is a flowchart illustrating an example of a method for controlling the communication terminal in accordance with the first embodiment.

### DESCRIPTION OF EMBODIMENTS

The following description will discuss an embodiment of the present invention in detail.

### [Communication System]

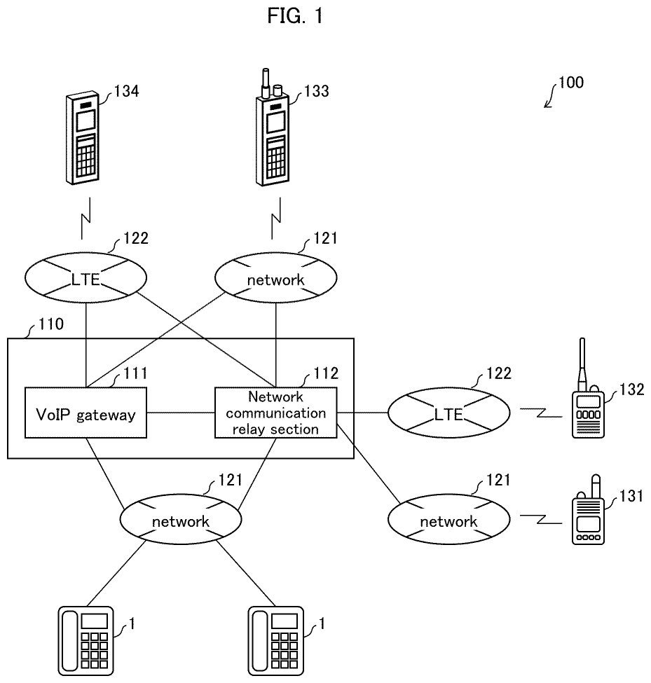

FIG. 1 is a view illustrating an example of a configuration of a communication system 100 including a communication terminal 1 in accordance with a first embodiment. In the example shown in FIG. 1, the communication system 100 includes a relay device 110, a communication terminal 1, and communication terminals 131, 132, 133, and 134.

The communication terminal 1 is a communication terminal capable of carrying out calling according to a plurality of communication methods. Specifically, the communication terminal 1 has a Push to Talk (PTT) call function which operates according to the PTT method by using an Internet Protocol (IP) network and an IP telephone call function which operates according to Session Initiation Protocol (SIP) via IP telephone communication. As will be described later, the communication terminal 1 may be connected to the IP network 121 via wired connection or wireless connection. In the description below, for convenience, communication according to the PTT method will be referred to as “IP wireless communication” and calling via the IP wireless communication will be referred to as an “IP wireless call function”, even in a case where the communication terminal is connected in a wired manner. The communication terminal 1 is connected to the IP network 121 via wired connection or wireless connection, and is connected to the relay device 110 via the IP network 121. A specific configuration of the communication terminal 1 will be described later. Note that the communication according to the PTT method is not limited to communication via the IP network, and may be carried out via another kind of communication network.

Each of the communication terminals 131 to 134 is a communication terminal capable of carrying out calling via the IP wireless communication or IP telephone communication. The communication terminal 131 is connected to the relay device 110 via the IP network 121, and carries out IP wireless communication. The communication terminal 132 is connected to the relay device 110 via a Long-Term Evolution (LTE) communication network 122 including a base station (not illustrated), and carries out IP wireless communication. The communication terminal 133 is connected to the relay device 110 via the IP network 121, and carries out IP wireless communication or IP telephone communication. The communication terminal 134 is connected to the relay device 110 via the LTE communication network 122, and carries out IP wireless communication or IP telephone communication.

The relay device 110 is a device including a Voice over Internet Protocol (VoIP) gateway 111 and a network communication relay section 112 which are integrated together. Note, however, that the communication system 100 does not necessarily need to include the relay device 110 including the VoIP gateway 111 and the network communication relay section 112 which are integrated together. Alternatively, the communication system 100 may include a VoIP gateway 111 and a network communication relay section 112 which are separately provided.

The VoIP gateway 111 is a gateway device which relays (a) VoIP procedures for transmitting a voice signal via the IP network 121 and (b) a communication terminal which carries out telephone communication. The VoIP gateway 111 relays IP telephone communication between the communication terminal 1 and the communication terminals 133 and 134 or relays IP telephone communication between the communication terminals 133 and 134. The communication terminal 134 is connected to the VoIP gateway 111 in the relay device 110 via the LTE communication network 122.

The VoIP gateway 111 includes a Session Initiation Protocol (SIP) server function. The SIP server function is a function for carrying out a calling control which uses the SIP protocol to associate a phone number (URI) with an IP address and make a call and connection to a telephone which is a destination of communication. Note that the communication system 100 may include, instead of the VoIP gateway 111, an Internet Protocol Private Branch exchange (IP-PBX) device which carries out circuit switching 4 a communication terminal having an IP telephone communication function.

The network communication relay section 112 relays communication between the communication terminal 1 and the communication terminals 131 to 134 or communication between the communication terminals 131 and 134. In particular, the network communication relay section 112 relays IP wireless communication between the communication terminal 1 and the communication terminals 131 to 134 or IP wireless communication between the communication terminals 131 to 134.

Further, the network communication relay section 112 receives a voice packet transmitted from the communication terminal 1 or the communication terminal(s) 131 and/or 133. Furthermore, on the basis of communication control information written in the voice packet, the network communication relay section 112 distributes a voice signal of this packet to the communication terminal 1 or the communication terminal(s) 131 and/or 133, which is/are a destination of communication. With this, a user can carry out voice communication via the IP network 121 while feeling as if the user is using a conventional transceiver.

Note that, in the relay device 110, the VoIP gateway 111 and the network communication relay section 112 may be connected to each other so as to enable calling between a communication terminal which is carrying out IP telephone communication and a communication terminal which is carrying out IP wireless communication.

### [Configuration of Communication Terminal]

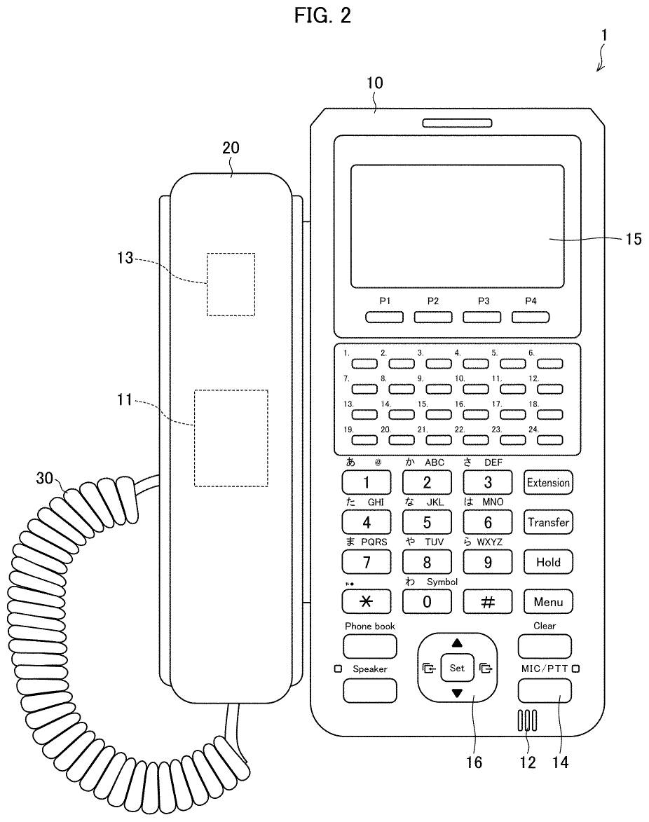

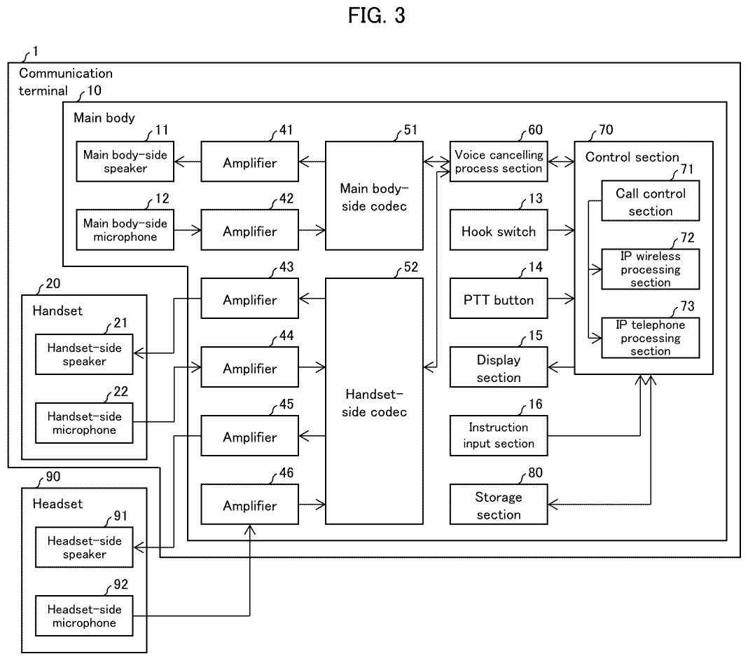

FIG. 2 is a plan view illustrating an example of an appearance of the communication terminal 1. FIG. 3 is a block diagram illustrating an example of a configuration of a main part of the communication terminal 1. In the example shown in FIGS. 2 and 3, the communication terminal 1 includes a main body 10, a handset 20, and a code 30. In FIG. 3, the code 30 is not illustrated.

The main body 10 includes a main body-side speaker 11 and a main body-side microphone 12. The main body-side speaker 11 outputs a voice while calling is carried out by the main body 10. The main body-side microphone 12 accepts input of a voice while calling is carried out by the main body 10.

The main body 10 further includes a hook switch 13. The hook switch 13 is pressed in a state where the handset 20 is in an on-hook state, and is released in a state where the handset 20 is in an off-hook state. That is, the hook switch 13 is a switch for determining whether or not the handset 20 is brought into an off-hook state.

The main body 10 further includes a PTT button 14. The PTT button 14 is a button for starting speech according to the PTT method. For example, the communication terminal 1 may start speech at a timing when a user presses the PTT button 14 and may end speech at a timing when the user releases the PTT button 14. Alternatively, the communication terminal 1 may start speech at a timing when the user presses and releases the PTT button 14 and may end speech at a timing when the user presses and releases the PTT button 14 again.

The main body 10 further includes a display section 15. The display section 15 displays information about operation of the communication terminal 1. The display section 15 may be a known display device such as a liquid crystal panel.

For example, while the IP wireless communication is carried out, the display section 15 displays information indicating that the IP wireless communication is carried out. For another example, while the IP telephone communication is carried out, the display section 15 may display information indicating that the IP telephone communication is carried out. With this, by checking the display section 15, the user can easily check the mode used for calling.

When an incoming call of the IP telephone communication arrives while the IP wireless communication is carried out or when an incoming call of the IP wireless communication arrives while the IP telephone communication is carried out, the display section 15 displays information indicative of the arrival.

The main body 10 further includes an instruction input section 16. The instruction input section 16 may be a button provided on a surface of the main body 10. However, this is not limitative. For example, the instruction input section 16 may be a touch panel provided so that the touch panel overlaps the display section 15. The instruction input section 16 accepts an instruction input from a user, the instruction input being for displaying, on the display section 15, at least one selected from the group consisting of a call destination list, a reception history or an incoming call history, and a transmission history or an outgoing call history.

When the input of the above instruction is accepted while the IP wireless communication is carried out, the display section 15 may display at least one selected from the group consisting of an address book, a reception history, and a transmission history relating to the IP wireless communication. Meanwhile, when the input of the above instruction is accepted while the IP telephone communication is carried out, the display section 15 may display at least one selected from the group consisting of a telephone book, an incoming call history, and an outgoing call history relating to the IP telephone communication.

Generally, different address books or telephone books for communication, different reception histories or incoming call histories, and different transmission histories or outgoing call histories are used for the IP wireless communication and the IP telephone communication. Causing the display section 15 to display at least one selected from the group consisting of the address book or telephone book, the reception history or transmission history, and the outgoing call history or incoming call history in the above-described manner makes it possible to cause the display section to display information corresponding to the communication method according to which communication is carried out at that time.

The handset 20 includes a handset-side speaker 21 and a handset-side microphone 22 (see FIG. 3). The handset-side speaker 21 outputs a voice while calling is carried out by the handset 20. The handset-side microphone 22 accepts input of a voice while calling is carried out by the handset 20. While communication is carried out by the handset 20, the user may grip the handset 20 at a position near his/her head so that the handset-side speaker 21 is located close to the user's ear and the handset-side microphone 22 is located close to the user's mouth.

The code 30 is a code which connects the main body 10 and the handset 20 to each other. The code 30 can be any known code, which can be selected without any limitation.

Further, a headset 90 is connectable to the communication terminal 1, as shown in FIG. 3. The user can connect the headset 90 to the communication terminal 1 and carry out calling. The headset 90 includes a headset-side speaker 91 and a headset-side microphone 92. The headset-side speaker 91 outputs a voice while calling is carried out by the handset 90. The headset-side microphone 92 accepts input of a voice while calling is carried out by the headset 90.

### [Detailed Configuration of Main Body]

The following will describe a detailed configuration of the main body 10.

The main body 10 includes amplifiers 41, 42, 43, 44, 45, and 46. The amplifier 41 amplifies a voice signal which is to be output to the main body-side speaker 11. The amplifier 42 amplifies a voice signal which is input from the main body-side microphone 12. The amplifier 43 amplifies a voice signal which is to be output to the handset-side speaker 21. The amplifier 44 amplifies a voice signal which is input from the handset-side microphone 22. The amplifier 45 amplifies a voice signal which is to be output to the headset-side speaker 91, in a case where the headset 90 is connected to the communication terminal 1. The amplifier 46 amplifies a voice signal which is input from the headset-side microphone 92, in a case where the headset 90 is connected to the communication terminal 1. Note that amplification for the handset-side speaker 21 and amplification for the headset-side speaker 91 may be carried out by a single amplifier and a destination of connection may be switched from one to another by a switch as appropriate. Similarly, amplification for the handset-side microphone 22 and amplification for the headset-side microphone 92 may be carried out by a single amplifier and a destination of connection may be switched from one to another by a switch as appropriate.

The main body 10 further includes a main body-side codec 51 and a handset-side codec 52. The communication terminal 1 transmits and receives an encoded voice signal. The main body-side codec 51 decodes a voice signal received from the outside, and outputs the decoded voice signal to the main body-side speaker 11. Further, the main body-side codec 51 encodes a voice signal which is input from the main body-side microphone 12.

The handset-side codec 52 decodes a voice signal received from the outside, and outputs the decoded voice signal to the handset-side speaker 21. Further, the handset-side codec 52 encodes a voice signal which is input from the handset-side microphone 22.

Further, in a case where the headset 90 is connected to the communication terminal 1 and the user carries out communication with the headset 90, the handset-side codec 52 decodes a voice signal received from the outside and outputs the decoded voice signal to the headset-side speaker 91. Moreover, in this case, the handset-side codec 52 encodes a voice signal which is input from the headset-side microphone 92.

The main body 10 further includes a voice cancelling process section 60. The voice cancelling process section 60 removes, from a voice signal which is input from the main body-side microphone 12 or the handset-side microphone 22, a voice signal which is output to the main body-side speaker 11 and the handset-side speaker 21. In a case where the headset 90 is connected to the communication terminal 1, the voice cancelling process section 60 removes, from a voice signal which is input from the main body-side microphone 12, the handset-side microphone 22, or the headset-side microphone 92, a voice signal which is output to the main body-side speaker 11, the handset-side speaker 21, and the headset-side speaker 91.

That is, the voice cancelling process

section 60 prevents (i) howling which may otherwise be caused when an output from the main body-side speaker 11 is input to the main body-side microphone 12 and (ii) howling which may otherwise by caused when an output from the handset-side speaker 21 is input to the handset-side microphone 22. Further, even in a case where the IP telephone communication is carried out by the handset 20, the voice cancelling process section 60 can cancel, from a voice signal of the handset-side microphone 22, not only an output from the handset-side speaker 21 but also an output from the main body-side speaker 11 to suppress or prevent the outputs from being mixed into calling carried out on the handset 20 side. Consequently, in any of a case where a voice signal is input from the main body-side microphone 12, a case where a voice signal is input from the handset-side microphone 22, and a case where a voice signal is input from the headset-side microphone 92, it is possible to improve the quality of a voice signal to be transmitted to the outside.

The main body 10 further includes a control section 70. The control section 70 controls operation of the communication terminal 1. The control section 70 includes a call control section 71, an IP wireless processing section (PTT call processing section) 72, and an IP telephone processing section 73.

The IP wireless processing section 72 carries out the IP wireless communication according to the PTT method via the IP network 121. The IP telephone processing section 73 carries out the IP telephone communication according to SIP via the IP network 121. The call control section 71 controls calling via the IP wireless processing section 72 and calling via the IP telephone processing section 73.

Specifically, in a case where the IP wireless communication is carried out by the main body-side speaker 11 and the main body-side microphone 12 at the time when the handset 20 is brought into an off-hook state, the call control section 71 controls calling via the IP wireless processing section 72 so that IP wireless communication is carried out by the handset 20. The “case where the IP wireless communication is carried out” herein refers to a case where calling is carried out via the IP wireless communication or a case where it is within a given period of time after reception of a voice via the IP wireless communication. The “given period of time” may be a period of time which is generally assumed as a blank time during calling, and may be five seconds, for example. Meanwhile, in a case where the IP wireless communication is not carried out at the time when the handset 20 is brought into an off-hook state, the call control section 71 controls calling via the IP telephone processing section 73 so that IP telephone calling according to the SIP is carried out by the handset 20.

According to the above-described control, in the communication terminal 1, it is determined, depending on whether or not the IP wireless communication is carried out at the time when the handset 20 is brought into an off-hook state, whether calling by the handset 20 is to be carried out via the IP wireless communication or the IP telephone communication. Thus, merely by hooking off the handset 20, a user can make a call in an appropriate call mode. In this case, the IP wireless communication continues until the handset 20 is brought into an on-hook state next time.

Further, in a case where neither the IP

wireless communication nor the IP telephone communication is carried out at the time when the handset 20 is brought into an off-hook state, the call control section 71 causes the handset-side speaker 21 to output a dial tone (DT) sound in the IP telephone communication. Further, if the PTT button 14 is pressed in this state, the call control section 71 starts the IP wireless communication.

By the above-described control, when the handset 20 is brought into an off-hook state in a state where neither the IP wireless communication nor the IP telephone communication is carried out, the communication terminal 1 first gets on standby in a state where the communication terminal 1 is ready to start the IP telephone communication. Thereafter, when the PTT button 14 is pressed, the communication terminal 1 starts the IP wireless communication. Also in this case, the IP wireless communication continues until the handset 20 is brought into an on-hook state.

Thus, when a user wishes to carry out the IP telephone communication, the user may simply hook off the handset 20 and carry out operation such as input of a phone number of a destination of communication. Meanwhile, when a user wishes to carry out the IP wireless communication, the user may hook off the handset 20 and press the PTT button. That is, with a natural motion, the user can start calling in a desired mode.

Further, as discussed above, when an incoming call of the IP telephone communication arrives while the IP wireless communication is carried out or when an incoming call of the IP wireless communication arrives while the IP telephone communication is carried out, the display section 15 displays information indicative of the arrival. At this time, in response to an instruction input from a user, the call control section 71 may carry out switching from the IP wireless communication to the IP telephone communication or switching from the IP telephone communication to the IP wireless communication. With this, when an incoming call of the IP telephone communication arrives while the IP wireless communication is carried out or when an incoming call of the IP wireless communication arrives while the IP telephone communication is carried out, the user can change the mode to a desired mode on the basis of the indication on the display section 15.

The subjects of control by the control section 70 are not limited to the processes of the call control section 71, the IP wireless processing section 72, and the IP telephone processing section 73. Alternatively, the control section 70 may control overall operation of the communication terminal 1. For example, the control section 70 controls the display section 15 so as to display the above-described information.

The main body 10 further includes the storage section 80. The storage section 80 is a storage device storing therein information that the control section 70 requires to control the communication terminal 1. Note, however, that the storage section 80 is not essential for the communication terminal 1. In a case where the communication terminal 1 does not include the storage section 80, the communication terminal 1 may be communicably connected to an external storage device.

### (Method for Controlling Communication Terminal)

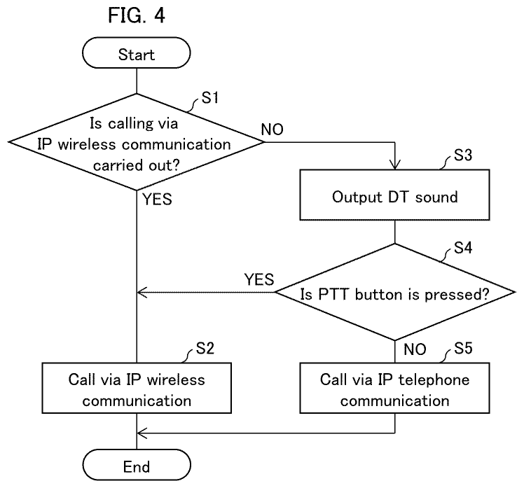

FIG. 4 is a flowchart illustrating an example of a method for controlling the communication terminal 1. The control method shown in FIG. 4 is started when the handset 20 is brought into an off-hook state.

When the handset 20 is brought into an off-hook state, the call control section 71 determines whether or not calling via the IP wireless communication is carried out by the main body-side speaker 11 and the main body-side microphone 12 at the time when the handset 20 is brought into an off-hook state (S1). In a case where calling via the IP wireless communication is carried out by the main body-side speaker 11 and the main body-side microphone 12 (YES in S1), the call control section 71 controls the IP wireless processing section 72 so that the IP wireless communication is carried out by the handset 20 (S2).

Meanwhile, in a case where calling via the IP wireless communication is not carried out by the main body-side speaker 11 or the main body-side microphone 12 (NO in S1), the call control section 71 causes the handset-side speaker 21 to output a DT sound (S3). In this state, the call control section 71 determines whether or not the PTT button 14 is pressed by the user (S4).

If the PTT button 14 is pressed by the user (YES in S4), the call control section 71 carries out control so that calling via the IP wireless communication is carried out by the handset 20 (S2). If the PTT button 14 is not pressed by the user (NO in S4), the call control section 71 controls the IP telephone processing section 73 so that calling via the IP telephone communication is carried out by the handset 20 (S5).

### [Software Implementation Example]

The functions of the communication terminal 1 (hereinafter, referred to as a “device”) can be realized by a program for causing a computer to function as the device, the program causing the computer to function as the control blocks (in particular, the sections of the control section 70) of the device.

In this case, the device includes, as hardware for executing the program, a computer which includes (i) at least one control device (e.g., processor) and (ii) at least one storage device (e.g., memory). By the control device and the storage device executing the program, the functions described in the foregoing embodiments are realized.

The program may be stored in one or more non-transitory, computer-readable storage media. The one or more storage media may or may not be provided to the device. In the latter case, the program may be supplied to the device via any wired or wireless transmission medium.

Further, some or all of the functions of the control blocks can be realized by a logic circuit. For example, the present invention encompasses, in its scope, an integrated circuit in which a logic circuit that functions as each of the control blocks is formed.

Aspects of the present invention can also be expressed as follows:

A communication terminal in accordance with a first aspect of the present invention includes: a Push to Talk call processing section which carries out Push to Talk calling according to a Push to Talk method; an Internet Protocol telephone processing section which carries out Internet Protocol telephone calling according to Session Initiation Protocol via an Internet Protocol network; a call control section which controls (a) Push to Talk calling via the Push to Talk call processing section and (b) Internet Protocol telephone calling via the Internet Protocol telephone processing section; a main body including a main body-side speaker and a main body-side microphone; and a handset including a handset-side speaker and a handset-side microphone, the call control section carrying out control so that (a) in a case where the Push to Talk calling is carried out by the main body-side speaker and the main body-side microphone at a time when the handset is brought into an off-hook state, the Push to Talk calling is carried out by the handset and (b) in a case where the Push to Talk calling is not carried out at a time when the handset is brought into an off-hook state, the Internet Protocol telephone calling is carried out by the handset.

According to the above-described configuration, depending on whether or not the PTT call is carried out at the time when the handset is brought into an off-hook state, the communication terminal capable of both the PTT calling and the IP telephone calling can switch calling carried out by the handset between the PTT calling or the IP telephone calling. Thus, merely by hooking off the handset, a user can make a call in an appropriate call mode.

A communication terminal in accordance with a second aspect of the present invention is configured such that, in the first aspect, the communication terminal further includes: a Push to Talk button for starting speech in the Push to Talk calling, wherein: in a case where neither the Push to Talk calling nor the Internet Protocol telephone calling is carried out at a time when the handset is brought into an off-hook state, the call control section causes the handset-side speaker to output a dial tone sound in the Internet Protocol telephone calling, and, in a case where the Push to Talk button is pressed in this state, the call control section starts the Push to Talk calling.

According to the above configuration, when the handset is brought into an off-hook state in a state where neither the PTT call nor the IP telephone call is carried out, the communication terminal first gets on standby in a state where the communication terminal is ready to start the IP telephone call. Thereafter, if the PTT button is pressed, the PTT calling starts. Thus, when a user wishes to carry out the IP telephone calling, the user may simply hook off the handset and carry out operation such as input of a phone number. Meanwhile, when a user wishes to carry out the PTT calling, the user may hook off the handset and press the PTT button. That is, with a natural motion, the user can start calling in a desired mode.

A communication terminal in accordance with a third aspect of the present invention is configured such that, in the first or second aspect, the communication terminal further includes: a display section which displays information, wherein: while the Push to Talk calling is carried out, the display section displays information indicating that the Push to Talk calling is carried out; and while the Internet Protocol telephone calling is carried out, the display section displays information indicating that the Internet Protocol telephone calling is carried out.

According to the above configuration, by checking the display section, the user can easily check the mode used for calling.

A communication terminal in accordance with a fourth aspect of the present invention is configured such that, in the third aspect, the communication terminal further includes: an instruction input section which accepts input of a user instruction for displaying, on the display section, at least one selected from the group consisting of an address book or a telephone book, a reception history or an incoming call history, and a transmission history or an outgoing call history, wherein: in a case where the input of the instruction is accepted while the Push to Talk calling is carried out, the display section displays at least one selected from the group consisting of an address book, a reception history, and a transmission history relating to the Push to Talk calling; and in a case where the input of the instruction is accepted while the Internet Protocol telephone calling is carried out, the display section displays at least one selected from the group consisting of a telephone book, an incoming call history, and an outgoing call history relating to the Internet Protocol telephone calling.

According to the above configuration, according to the mode that is active, the communication terminal can display, on the display section, at least one selected from the group consisting of the address book or telephone book, the reception history or incoming call history, and the transmission history or outgoing call history.

A communication terminal in accordance with a fifth aspect of the present invention is configured such that, in the third or fourth aspect, in a case where an incoming Internet Protocol telephone call arrives while the Push to Talk calling is carried out or in a case where an incoming Push to Talk call arrives while the Internet Protocol telephone calling is carried out, the display section displays information indicative of the arrival, and, in response to input of a user instruction, the call control section carries out switching from the Push to Talk calling to the Internet Protocol telephone calling or switching from the Internet Protocol telephone calling to the Push to Talk calling.

According to the above configuration, in a case where an incoming IP telephone call or an incoming PTT call arrives while the PTT calling or the IP telephone calling is carried out, the user can change the mode to a desired mode on the basis of the indication on the display section.

A communication terminal in accordance with a sixth aspect of the present invention is configured such that, in any one of the first to fifth aspects, the Push to Talk call processing section carries out the Push to Talk calling via the Internet Protocol network.

According to the above configuration, for the PTT calling and the IP telephone calling via the IP network, the user can make a call in an appropriate mode merely by hooking off the handset.

A method for controlling a communication terminal in accordance with a seventh aspect of the present invention is a method for controlling a communication terminal that includes: a Push to Talk call processing section which carries out Push to Talk calling according to a Push to Talk method; an Internet Protocol telephone processing section which carries out Internet Protocol telephone calling according to Session Initiation Protocol via an Internet Protocol network; a main body which includes a main body-side speaker and a main body-side speaker; and a handset which includes a handset-side speaker and handset-side microphone, the method including the steps of: controlling the Push to Talk call processing section so that, in a case where the Push to Talk calling is carried out by the main body-side speaker and the main body-side microphone at a time when the handset is brought into an off-hook state, the Push to Talk calling is carried out by the handset; and controlling the Internet Protocol telephone processing section so that, in a case where the Push to Talk calling is not carried out at a time when the handset is brought into an off-hook state, the Internet Protocol telephone calling is carried out by the handset.

The above configuration provides similar effects to those of the above-described first aspect.

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1: communication terminal

10: main body

11: main body-side speaker

12: main body-side microphone

13: hook switch

14: PTT button

15: display section

16: instruction input section

20: handset

21: handset-side speaker

22: handset-side microphone

71: call control section

72: IP wireless processing section (PTT call processing section)

73: IP telephone processing section

1. A communication terminal comprising:
a Push to Talk call processing section which carries out Push to Talk calling according to a Push to Talk method;
an Internet Protocol telephone processing section which carries out Internet Protocol telephone calling according to Session Initiation Protocol via an Internet Protocol network;
a call control section which controls (a) Push to Talk calling via the Push to Talk call processing section and (b) Internet Protocol telephone calling via the Internet Protocol telephone processing section;
a main body including a main body-side speaker and a main body-side microphone; and
a handset including a handset-side speaker and a handset-side microphone,
the call control section carrying out control so that
(a) in a case where the Push to Talk calling is carried out by the main body-side speaker and the main body-side microphone at a time when the handset is brought into an off-hook state, the Push to Talk calling is carried out by the handset and
(b) in a case where the Push to Talk calling is not carried out at a time when the handset is brought into an off-hook state, the Internet Protocol telephone calling is carried out by the handset.

2. The communication terminal according to claim 1, further comprising:
a Push to Talk button for starting speech in the Push to Talk calling, wherein:
in a case where neither the Push to Talk calling nor the Internet Protocol telephone calling is carried out at a time when the handset is brought into an off-hook state, the call control section causes the handset-side speaker to output a dial tone sound in the Internet Protocol telephone calling, and, in a case where the Push to Talk button is pressed in this state, the call control section starts the Push to Talk calling.

3. The communication terminal according to claim 1, further comprising:
a display section which displays information, wherein:
while the Push to Talk calling is carried out, the display section displays information indicating that the Push to Talk calling is carried out; and
while the Internet Protocol telephone calling is carried out, the display section displays information indicating that the Internet Protocol telephone calling is carried out.

4. The communication terminal according to claim 3, further comprising:
an instruction input section which accepts an instruction input from a user, the instruction input being for displaying, on the display section, at least one selected from the group consisting of an address book or a telephone book, a reception history or an incoming call history, and a transmission history or an outgoing call history, wherein:
in a case where the input of the instruction is accepted while the Push to Talk calling is carried out, the display section displays at least one selected from the group consisting of an address book, a reception history, and a transmission history relating to the Push to Talk calling; and
in a case where the input of the instruction is accepted while the Internet Protocol telephone calling is carried out, the display section displays at least one selected from the group consisting of a telephone book, an incoming call history, and an outgoing call history relating to the Internet Protocol telephone calling.

5. The communication terminal according to claim 3, wherein:
in a case where an incoming Internet Protocol telephone call arrives while the Push to Talk calling is carried out or in a case where an incoming Push to Talk call arrives while the Internet Protocol telephone calling is carried out, the display section displays information indicative of the arrival; and
in response to input of a user instruction, the call control section carries out switching from the Push to Talk calling to the Internet Protocol telephone calling or switching from the Internet Protocol telephone calling to the Push to Talk calling.

6. The communication terminal according to claim 1, wherein:
the Push to Talk call processing section carries out the Push to Talk calling via the Internet Protocol network.

7. A method for controlling a communication terminal that includes: a Push to Talk call processing section which carries out Push to Talk calling according to a Push to Talk method; an Internet Protocol telephone processing section which carries out Internet Protocol telephone calling according to Session Initiation Protocol via an Internet Protocol network; a main body which includes a main body-side speaker and a main body-side speaker; and a handset which includes a handset-side speaker and handset-side microphone, the method comprising the steps of:
controlling the Push to Talk call processing section so that, in a case where the Push to Talk calling is carried out by the main body-side speaker and the main body-side microphone at a time when the handset is brought into an off-hook state, the Push to Talk calling is carried out by the handset; and
controlling the Internet Protocol telephone processing section so that, in a case where the Push to Talk calling is not carried out at a time when the handset is brought into an off-hook state, the Internet Protocol telephone calling is carried out by the handset.
